(19) United States
(12) Patent Application Publication
(10) Pub. No.: US 2014/0092754 A1
(43) Pub. Date: Apr. 3, 2014

(54) PACKET TAGGING MECHANISM

(71) Applicant: FLUKE CORPORATION, Everett, WA (US)

(72) Inventors: James W. Kisela, Snohomish, WA (US); Steve Koller, Yorktown Heights, NY (US); William Winston, Lake Stevens, WA (US)

(73) Assignee: Fluke Corporation, Everett, WA (US)

(21) Appl. No.: 13/630,306

(22) Filed: Sep. 28, 2012

(51) Int. Cl. H04L 12/26

(52) U.S. Cl. CPC H04L 43/04
USPC 370/250

(57) ABSTRACT

A method is disclosed. The method includes capturing a first packet at a network monitoring card, capturing the first packet at a first filter, generating a first tag corresponding to the first filter and storing the first packet in memory with the first tag.

### BACKGROUND

This invention relates to network test and measurement, and more particularly to an apparatus and method for tagging packets in network traffic.

In operation and maintenance of networks, determination of where issues or problem points arise can be complex. Thus, a test instrument/analyzer may be implemented for such determinations. Such an instrument typically includes one or more network interfaces that capture packets from a network and forward the packets to a processor for analysis.

During the analysis process different types of packets are decoded in order to find the desired information needed for testing. However, finding the information may be difficult because data may vary widely within each packet. Subsequently, a determination is to be made as to where the packet is to be transmitted (e.g., what subsequent processing step (capture, analyze, discard, etc.) is to next be performed on the packet). The above-described transactions are typically performed using software executed on the host processor. Having to perform such transactions via software negatively impacts the performance of the host processor.

### SUMMARY

In one embodiment, a method is disclosed. The method includes capturing a first packet at a network monitoring card, capturing the first packet at a first filter, generating a first tag corresponding to the first filter and storing the first packet in memory with the first tag.

### BRIEF DESCRIPTION OF THE DRAWINGS

A better understanding of the present invention can be obtained from the following detailed description in conjunction with the following drawings, in which:

FIG. 1 is a block diagram of one embodiment of a network with a test instrument installed thereon;

FIG. 2 is a block diagram of one embodiment of a test instrument;

FIG. 3 is a block diagram of one embodiment of a network monitoring card; and

FIG. 4 is a flow diagram illustrating one embodiment of a packet tagging process.

### DETAILED DESCRIPTION

A packet tagging mechanism is disclosed. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

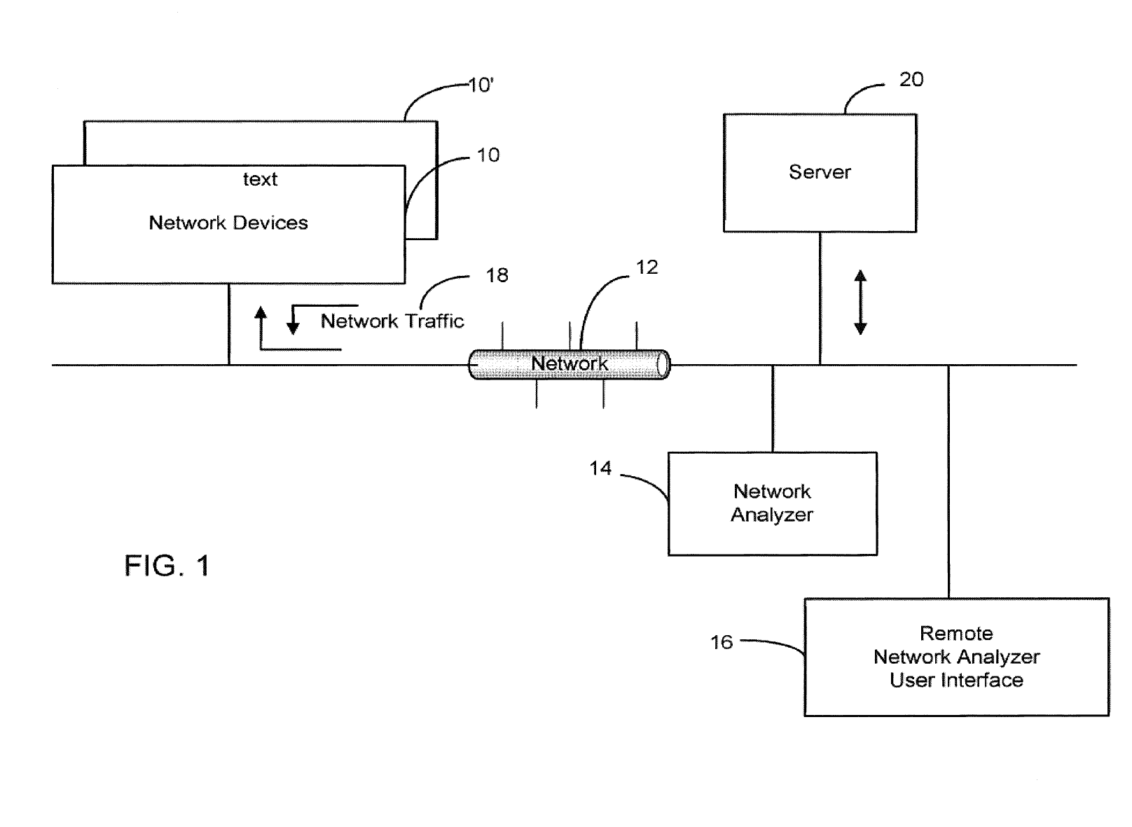

FIG. 1 illustrates one embodiment of a block diagram of a network with an apparatus. The network includes a multitude of network devices 10 that communicate over a network 12 by transmitting and receiving network traffic 18. The traffic may be sent in packet form, with varying protocols and formatting thereof.

A network analyzer 14 is also coupled to the network, and may include a remote network analyzer user interface 16. Remote network analyzer user interface 16 enables a user to interact with network analyzer 14 to operate analyzer 14 and remotely obtain data therefrom. In one embodiment, remote network analyzer user interface 16 typically is operated by running on a computer or workstation interfaced with the network.

According to one embodiment, network analyzer 14 includes hardware and software, CPU, memory, interfaces that operate to monitor traffic on the network. In a further embodiment, network analyzer 14 performs various testing and measurement operations, as well as transmitting and receiving data.

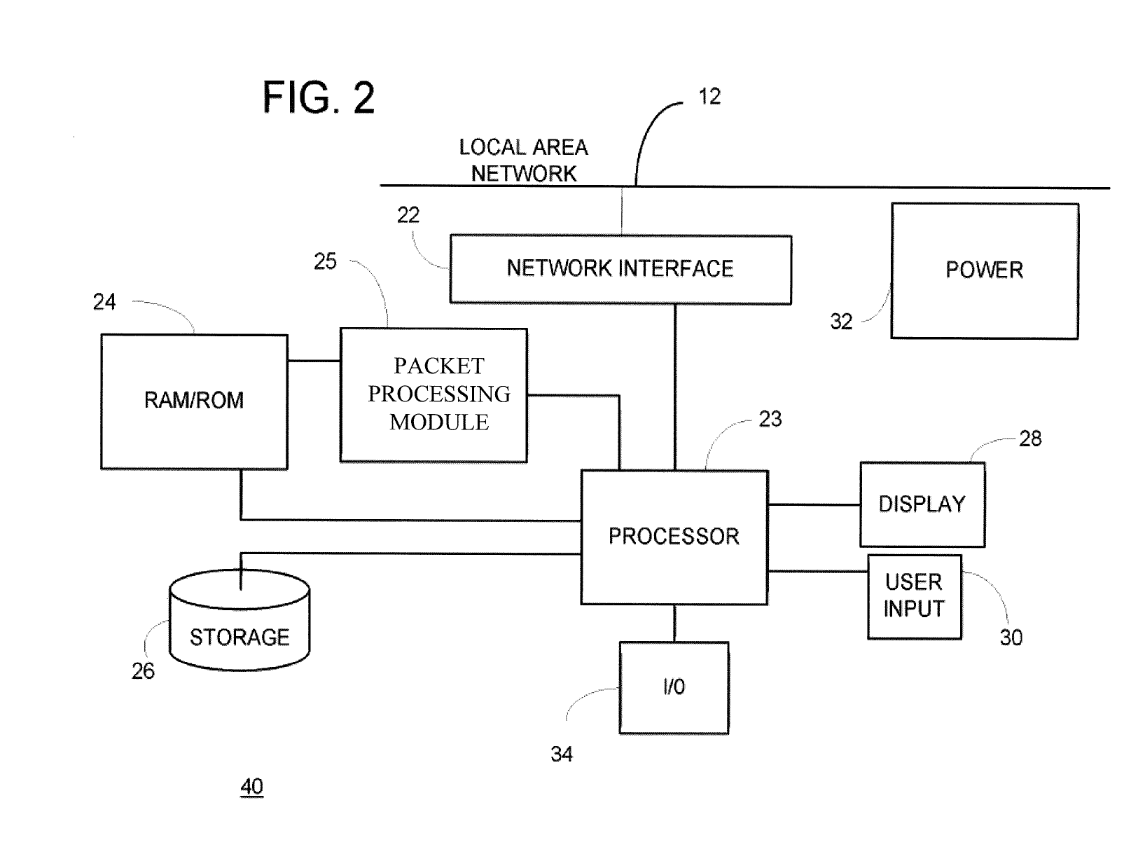

FIG. 2 is a block diagram illustrating one embodiment of network analyzer 14. According to one embodiment, network analyzer 14 includes network interfaces 22 that couple to network 12 via multiple ports. Network analyzer 14 also includes one or more processors 23, memory such as RAM/ROM 24 and persistent storage 26, and display 28. Further, user input devices 30 (e.g., keyboard, mouse or other pointing devices, touch screen, etc.), a power supply 32 and an input/output interface 34 to couple to another network or external devices (e.g., storage, other computer, etc.) are included within network analyzer 14.

In one embodiment, network analyzer 14 includes a packet processing module 25 to process packets received at analyzer 14. In such an embodiment, processing of the packets includes adding a header (or tag) to each packet received via network interfaces 22. According to one embodiment, packet processing module 25 may be implemented as a network monitoring card.

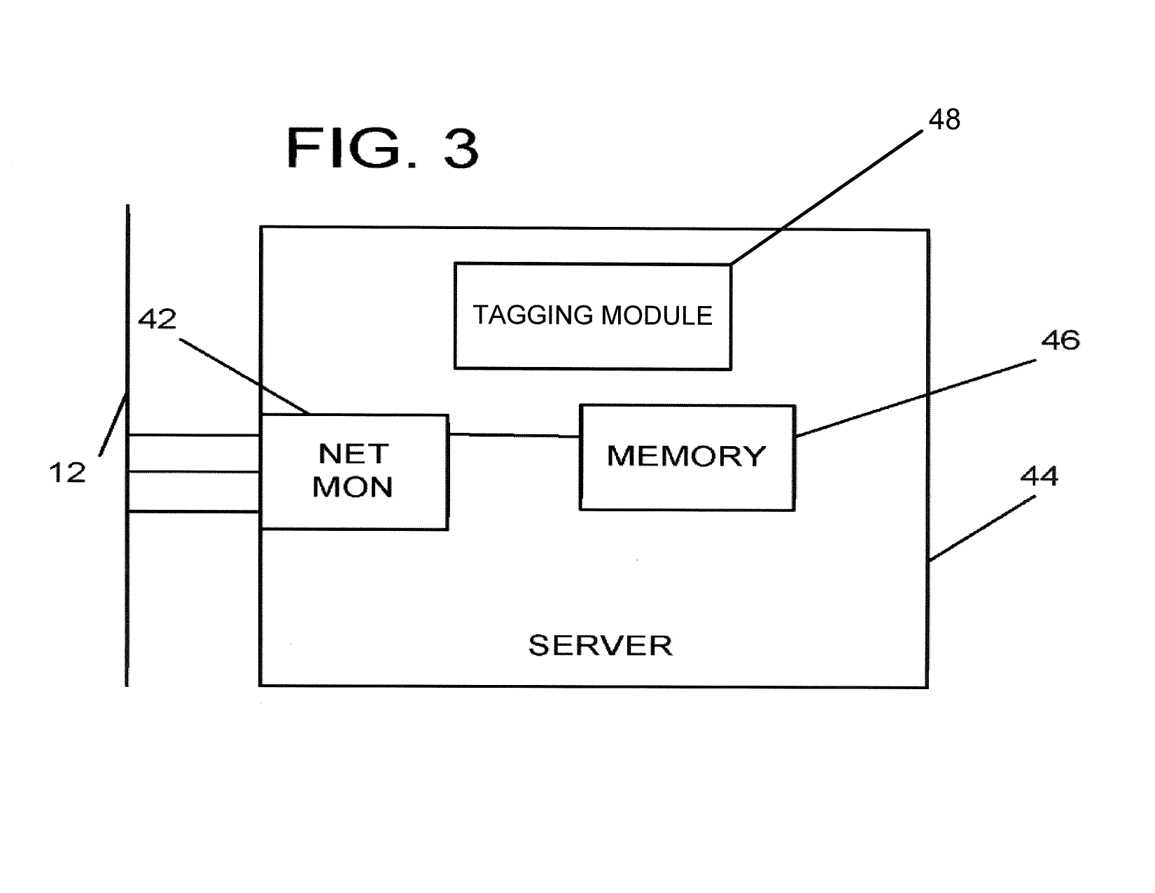

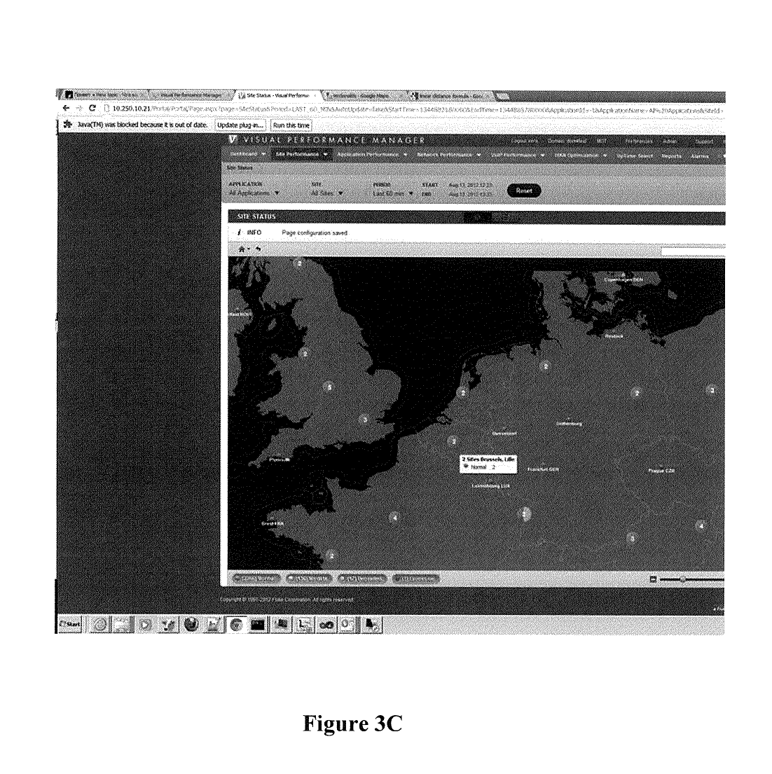

FIG. 3 is a block diagram illustrating one embodiment of such a network monitoring card 42 inserted into a PCIe slot in a high-performance server 44. According to one embodiment, network monitoring card 42 filters, aggregates, and buffers Ethernet traffic received from network 12 over multiple ports at line rates. Server 44 also includes a memory 46 to store packets received from card 42.

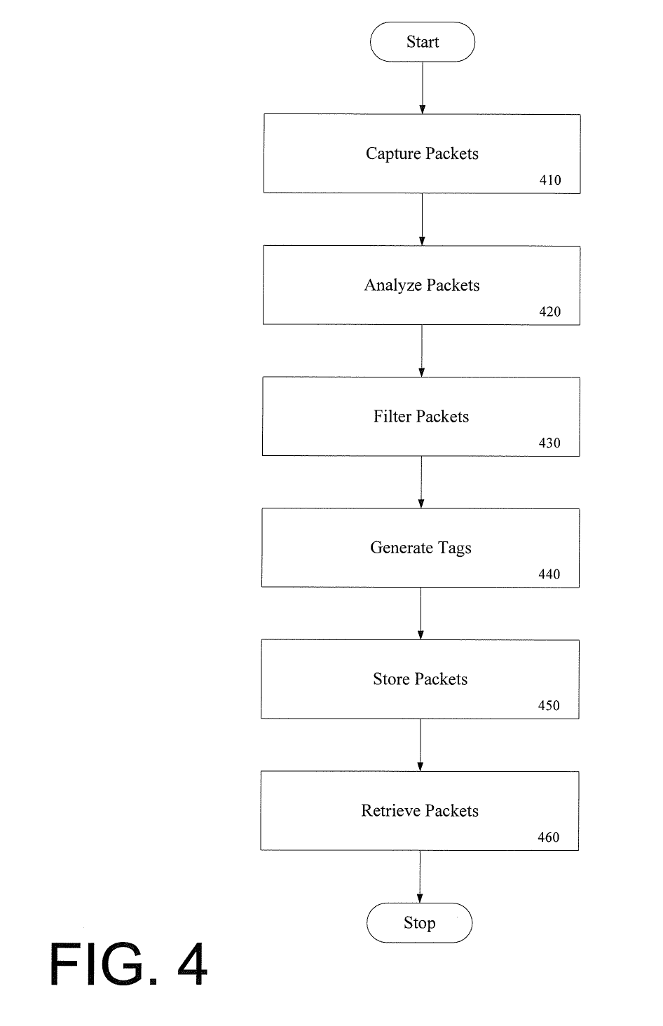

FIG. 4 is a flow diagram illustrating one embodiment of a packet tagging process. At processing block 410, packets are captured at network monitoring card 42. At processing block 420, the card 42 hardware analyzes each captured using filters. In one embodiment, each packet is compared against various filters for IP address, port number, packet length and/or keywords. In such an embodiment, the filters are configurable in the card 42 hardware. As an example, card 42 may include a filter “X” configured to capture all received HTTP traffic.

At processing block 430, the packets are captured at one or more filters based on a criteria match. For example, packets that match a criteria “X” are captured by filter “X”, packets that match a criteria “Y” are captured by another filter “Y”. At processing block 440, a tag is generated for each packet by a tagging module 48 based on the filter results.

In one embodiment, tagging module 48 is a software module that generates a packet report for each packet that corresponds to the matching filter. Thus, the packet report includes a unique ID that indicates that a packet has been captured because the packet matches the filter. In such an embodiment, the packet report is header data that is stored with the packet in memory 46 to assist in the routing and processing of the packet. For example, each packet captured at card 42 may include a fixed data length (e.g., 100 B), while the packet report tag is an additional length (e.g., 20 B, 48 B, etc.).

At processing block 450, each packet and corresponding tag is stored at memory 46. At processing block 460, each packet and tag are subsequently retrieved by a process that determines a particular action that is to be performed for each packet based on the tag. In one embodiment, actions to be performed on a packet are determined by predetermined rules configured for the filters.

The above-described process obviates the need for the software to inspect each full packet to determine an action to take. Instead, the software only needs to analyze the shorter tag. Thus, performance is improved due to the increased speed at which the software can make decisions about packets.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A method comprising:
capturing a first packet at a network monitoring card;
capturing the first packet at a first filter;
generating a first tag corresponding to the first filter; and
storing the first packet in memory with the first tag.

2. The method of claim 1 further comprising analyzing the first packet upon capturing the first packet at the network monitoring card.

3. The method of claim 2 wherein analyzing the first packet comprises comparing the first packet against one or more filters.

4. The method of claim 3 wherein the first packet is compared against the one or more filters for one or more of IP address, port number, packet length or keywords.

5. The method of claim 1 further comprising:
retrieving the first packet and first tag from memory; and
analyzing the first tag to determine an action to be performed on the first packet.

6. The method of claim 1 further comprising:
capturing a second packet at the network monitoring card;
capturing the second packet at a second filter;
generating a second tag corresponding to the second filter; and
storing the second packet in memory with the second tag.

7. The method of claim 6 wherein the first tag includes a first unique ID corresponding to the first filter and the second tag includes a second unique ID corresponding to the second filter.

8. An apparatus comprising:
network monitoring card including a first filter to capture a first packet received at the network monitoring card;
a tagging module to generate a first tag corresponding to the first filter; and
a memory to store the first packet with the first tag.

9. The apparatus of claim 8 wherein the network monitoring card analyzes the first packet upon capturing the first packet.

10. The apparatus of claim 9 wherein analyzing the first packet comprises comparing the first packet against one or more filters.

11. The apparatus of claim 10 wherein the first packet is compared against the one or more filters for one or more of IP address, port number, packet length or keywords.

12. The apparatus of claim 8 wherein the network monitoring card further comprises a second filter to capture a second packet received at the network monitoring card.

13. The apparatus of claim 12 wherein the tagging module generates a second tag corresponding to the second filter.

14. The apparatus of claim 13 wherein the second packet is stored in the memory with the second tag.

15. The apparatus of claim 13 wherein the first and second packets are retrieved from memory and the first and second tags are analyzed to determine an action to be performed on the first and second packets.

16. The apparatus of claim 13 wherein the first tag includes a first unique ID corresponding to the first filter and the second tag includes a second unique ID corresponding to the second filter.

17. An article of manufacture including a non-volatile memory including instructions, which when executed by a processor, causes the processor to:
capture the first packet at a first filter;
generate a first tag corresponding to the first filter; and
store the first packet in memory with the first tag.

18. The article of manufacture of claim 17 including a non-volatile memory including instructions, which when executed by a processor, further causes the processor to analyze the first packet upon capturing the first packet.

19. The article of manufacture of claim 17 wherein analyzing the first packet comprises comparing the first packet against one or more filters.

20. The article of manufacture of claim 17 including a non-volatile memory including instructions, which when executed by a processor, further causes the processor to:
retrieve the first packet and first tag from memory; and
analyze the first tag to determine an action to be performed on the first packet.
